(19) United States
(12) Patent Application Publication
(10) Pub. No.: US 2018/0103251 A1
(43) Pub. Date: Apr. 12, 2018

(54) METHOD FOR SELECTING PREDICTION MODE OF INTRA PREDICTION, VIDEO ENCODING DEVICE AND IMAGE PROCESSING APPARATUS

(71) Applicant: Industrial Technology Research Institute, Hsinchu (TW)

(72) Inventors: Chun-Lung Lin, Taipei City (TW); Ching-Chieh Lin, Taipei City (TW); Po-Han Lin, Taipei City (TW)

(73) Assignee: Industrial Technology Research Institute, Hsinchu (TW)

(21) Appl. No.: 15/725,300

(22) Filed: Oct. 5, 2017

Related U.S. Application Data
(60) Provisional application No. 62/405,252, filed on Oct. 7, 2016.

(30) Foreign Application Priority Data
Sep. 29, 2017 (CN) 201710910588.8
Sep. 29, 2017 (TW) 106133482

(51) Int. Cl. H04N 19/103; H04N 19/61; H04N 19/147

(52) U.S. Cl. CPC H04N 19/103; H04N 19/147; H04N 19/61

(57) ABSTRACT

A method for selecting a prediction mode of an intra prediction, a video encoding device and an image processing apparatus are provided. The method includes following steps. Multiple prediction costs corresponding to multiple prediction modes of the intra prediction are calculated according to a block of an input image in case that a transform unit transforms according to a default transform index. Multiple candidate prediction modes are selected from the prediction modes based on the prediction costs corresponding to the prediction modes. Multiple distortion costs corresponding to the candidate prediction modes under a plurality of transform indexes are calculated based on the block and the prediction costs corresponding to the candidate prediction modes. And, one of the candidate prediction modes is selected according to the distortion costs to serve as a prediction mode to be used of the intra prediction corresponding to the block.

### CROSS-REFERENCE TO RELATED APPLICATION

This application claims the priority benefits of U.S. provisional application Ser. No. 62/405,252, filed on Oct. 7, 2016, and Taiwan application serial no. 106133482, filed on Sep. 29, 2017, and China application serial no. 201710910588.8, filed on Sep. 29, 2017. The entirety of each of the above-mentioned patent applications is hereby incorporated by reference herein and made a part of this specification.

### BACKGROUND OF THE DISCLOSURE

### Field of the Disclosure

The disclosure relates to a method for selecting a prediction mode of an intra prediction, a video encoding device and an image processing apparatus.

### Description of Related Art

Along with recent development of new techniques of applications such as networks, communication systems, displays and computers, many applications require a high efficiency video encoding solution, for example, a high video compression rate, virtual reality (VR) and 360-degree video content. In order to provide an immersive visual effect, a common practise is to enhance a video resolution, so as to view more details in the video. The VR technique is generally implemented through a head mounted device (HMD), and a distance between the HMD and the eyes is very close, so that a resolution of the video content is hopefully increased to the current 4K to 8K resolution, or even 3K resolution or more. Moreover, a frame fresh rate may also influence a user experience of the VR, so that the frame refresh rate is hopefully increased to 30 frames/second, 90 frames/second or even 120 frames/second. Based on the aforementioned requirements, the currently used high efficiency video coding (HEVC) (which is also referred to as H.265) seems to be unable to provide a better visual effect and experience for the user.

In order to further improve coding efficiency of digital video and improve image quality, the joint video exploration team (JVET) applies a plurality of enhanced video coding techniques that solve potential needs to a joint exploration test model (JEM), so as to try to promote a progress of the video encoding technology. An intra prediction technique adopted by the JEM expands the original 35 prediction modes of the HEVC to 67 prediction modes, so as to implement more accurate angle prediction.

Moreover, the JEM further introduces a mode-dependent non-separable secondary transform (NSST) technique in a transform unit (TU). The NSST may be implemented between a primary transform (which is also referred to as a core transform or a first transform) and quantization of a video encoder, and the NSST may also be implemented in de-quantization and reverse primary transform of the video encoder. The NSST may achieve better compression efficiency in directional texture pattern, though a complicated computation is required.

### SUMMARY OF THE DISCLOSURE

The disclosure is directed to a method for selecting prediction mode of intra prediction, a video encoding device and an image processing apparatus, which are adapted to improve efficiency and processing speed of video encoding and meanwhile decrease hardware implementation cost of the video encoding.

The disclosure provides a method for selecting a prediction mode of an intra prediction, which includes following steps. A plurality of prediction costs corresponding to a plurality of prediction modes of the intra prediction is calculated according to a block of an input image in case that a transform unit operates according to a default transform index. A plurality of candidate prediction modes is selected from the prediction modes based on the prediction costs. A plurality of distortion costs corresponding to the candidate prediction modes under a plurality of transform indexes is calculated based on the block and the prediction costs corresponding to the candidate prediction modes. One of the candidate prediction modes is selected according to the distortion costs to serve as a prediction mode to be used of the intra prediction corresponding to the block.

The disclosure provides a video encoding device at least including a transform unit and an intra prediction unit. The transform unit is configured to transform a residual value corresponding to a block of an input image according to a plurality of transform indexes. The intra prediction unit is coupled to the transform unit. In case that the transform unit operates according to a default transform index, the intra prediction unit obtains the block of the input image, and calculates a plurality of prediction costs corresponding to a plurality of prediction modes of an intra prediction according to the block. The default transform index is one of the transform indexes. The intra prediction unit selects a plurality of candidate prediction modes from the prediction modes based on the prediction costs, calculates a plurality of distortion costs corresponding to the candidate prediction modes under the transform indexes of the transform unit based on the block and the prediction costs corresponding to the candidate prediction modes, and selects one of the candidate prediction modes according to the distortion costs to serve as a prediction mode to be used of the intra prediction corresponding to the block.

The disclosure provides an image processing apparatus including a processor and a memory. The processor calculates a plurality of prediction costs corresponding to a plurality of prediction modes of an intra prediction according to a block of an input image in case of transforming a residual value according to a default transform index. The residual value corresponds to the block. The processor selects a plurality of candidate prediction modes from the prediction modes based on the prediction costs, calculates a plurality of distortion costs corresponding to the candidate prediction modes under a plurality of transform indexes based on the block and the prediction costs corresponding to the candidate prediction modes. The default transform index is one of the transform indexes. The processor selects one of the candidate prediction modes according to the distortion costs to serve as a prediction mode to be used of the intra prediction corresponding to the block.

According to the above descriptions, when the method for selecting prediction mode of intra prediction, the video encoding device and the image processing apparatus select the prediction mode of the intra prediction, the transform unit is set to the default transform index (for example, the transform unit is set to an operation mode that a second transform unit is disabled and only a first transform unit is used for transforming the residual value), and then the prediction costs corresponding to each of the prediction modes of the intra prediction are calculated based on the block of the input image, so as to select the candidate prediction modes from the prediction modes. Then, the candidate prediction mode with the optimal (for example, the lowest) distortion cost is selected from the candidate prediction modes according to the prediction costs corresponding to the candidate prediction modes and the block to serve as the prediction mode to be used. In other words, the embodiment of the disclosure does not respectively calculate the prediction cost corresponding to each of the prediction modes for different operation modes in the transform unit (i.e. in case that the residual value is transformed according to different transform indexes), but calculates the prediction costs corresponding to each of the prediction modes of the intra perdition once for a default operation mode of the transform unit (i.e. in case that the residual value is transformed according to the default transform index). Then, calculation of the distortion costs is implemented through the aforementioned prediction costs in collaboration with a situation that the transform unit transforms the residual value according to different transform indexes, so as to implement the subsequent selection of the candidate prediction modes. In this way, in the embodiments of the disclosure, a computation amount of the prediction costs is greatly decreased, the efficiency of video encoding and processing speed thereof are improved, and meanwhile the hardware implementation cost of the video encoding is decreased.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a structural block diagram of a video encoding device according to an embodiment of the disclosure.

FIG. 2 is a block diagram of an image processing apparatus according to an embodiment of the disclosure.

FIG. 3 is a schematic diagram of two stages of intra prediction of a joint exploration test model (JEM).

FIG. 4 is a flowchart illustrating a method for selecting a prediction mode of an intra prediction according to an embodiment of the disclosure.

### DESCRIPTION OF EMBODIMENTS

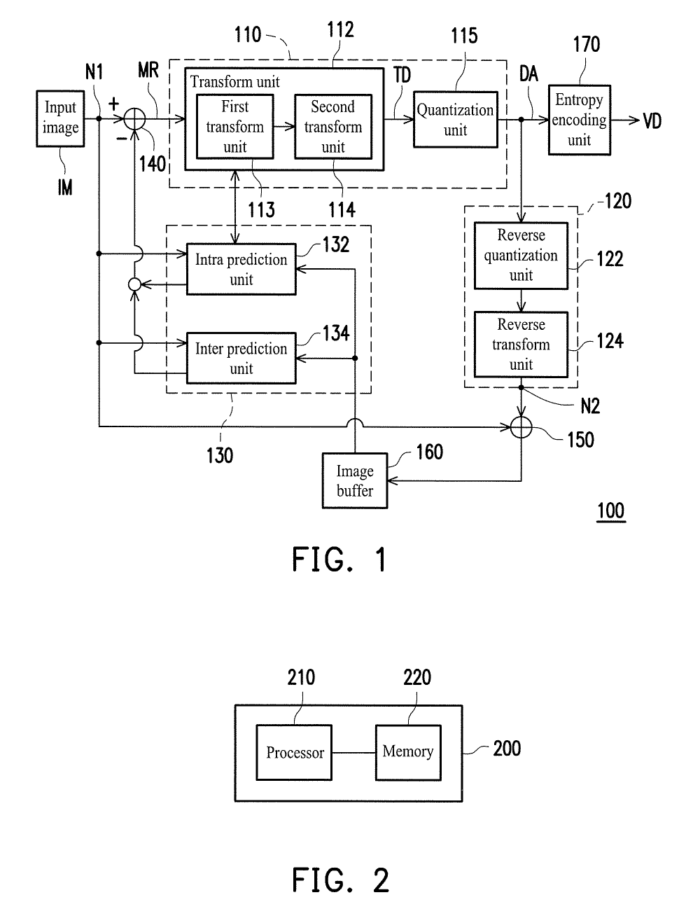

FIG. 1 is a structural block diagram of a video encoding device 100 according to an embodiment of the disclosure. The video encoding deice 100 performs video encoding according to a plurality of input images IM of an obtained input image, so as to decrease a data amount of the input image, such that the input image is easy to be transferred and stored. The video encoding used by the video encoding device 100 may be a joint exploration test model (JEM), or video encoding having a first transform and a second transform (for example, non-separable secondary transform (NSST)) in the video transform that is complied with the spirit of the embodiment of the disclosure.

The video encoding deice 100 of the present embodiment mainly includes a transform and quantization unit 110, a reverse quantization and reverse transform unit 120, a prediction unit 130, an adder 140 located at an input terminal N1 of the video encoding device 100, an adder 150 located at an output terminal N2 of the reverse quantization and reverse transform unit 120, an image buffer 160 and an entropy encoding unit 170. The transform and quantization unit 110 includes a transform unit 112 and a quantization unit 115. The prediction unit 130 includes an intra prediction unit 132 and an inter prediction unit 134. The adder 140 subtracts information provided by the prediction unit 130 from the input image IM to obtain a residual value MR of the input image IM.

In the JEM, the transform unit 112 includes a first transform unit 113 and a second transform unit 114. The first transform unit 113 performs a first transform (which is also referred to as a core transform or a primary transform) on the residual value MR of the input image IM. The second transform unit 114 performs a second transform on the residual value MR that has been subjected to the first transform. The second transform is a mode-dependent NSST. Residual value processing of the NSST may be related to an intra prediction mode selected and used by the prediction unit (for example, the intra prediction unit 132). The NSST in the JEM may have three transform cores, and the intra prediction unit 132 may use the transform cores to strengthen effectiveness of residual value encoding. In other words, the JEM may selectively enable the first transform and one of the three transform cores in the NSST to perform the residual value encoding, or only enables the first transform and disables the NSST to perform the residual value encoding. In the present embodiment, a plurality of “transform indexes” is applied to represent operation modes of the NSST. One of the transform indexes represents that the transform unit 112 does not use the second transform unit 114 to transform the residual value of a current block, and such operation mode may be represented by a “default transform index”. Other transform indexes except the default transform index represent an operation mode that the transform unit 112 uses one of the at least one transform core (the NSST of the disclosure has three transform cores) in the second transform unit 114 to transform the residual value of the current block. In other words, the disclosure has four transform indexes to respectively represent disabling NSST (the transform index is “0”), using the first transform core to perform the NSST (the transform index is “1”), using the second transform core to perform the NSST (the transform index is “2”), and using the third transform core to perform the NSST (the transform index is “3”).

Data TD that has been subjected to the residual value transform of the transform unit 112 is processed by the quantization unit 115 to form data DA, and the data DA is processed by the entropy encoding unit 170 to become compressed video data VD. Besides the data DA, the video data VD may also include various intra prediction modes and inter prediction modes produced by the prediction unit 130.

In order to simulate data after video decoding, the video encoding device 100 uses a reverse quantization unit 122 and a reverse transform unit 124 in the reverse quantization and reverse transform unit 120 to restore the data DA into image data after the video decoding. The image data is temporarily stored in the image buffer 160 through processing of the adder 150 with the input image IM. The video-decoded image data may be provided to the intra prediction unit 132 and the inter prediction unit 134 for mode prediction of the current block.

The intra prediction unit 132 is to use resolved blocks in a same image to perform pixel value prediction and the residual value transform to the currently processing block. The inter prediction unit 134 is to perform the pixel value prediction and the residual value transform to blocks between a plurality of consecutive input images.

The various functional blocks in FIG. 1 may be implement in a hardware form, or implemented by a software program or a firmware module. FIG. 2 is a block diagram of an image processing apparatus 200 according to an embodiment of the disclosure. When the video encoding device 100 in FIG. 1 is implemented by the software program or the firmware module, the software program or the firmware module may be executed through a processor 210 and a memory 220 in the image processing apparatus 200 to implement the embodiment of the disclosure. The memory 220 may store various software programs or firmware modules in the video encoding device 100 presented in form of instruction. The processor 210 may access the memory 220 to execute the software programs or the firmware modules. The processor 210 may be a central processing unit, a graphics processing unit, a microprocessor, a field programmable logic gate array, etc.

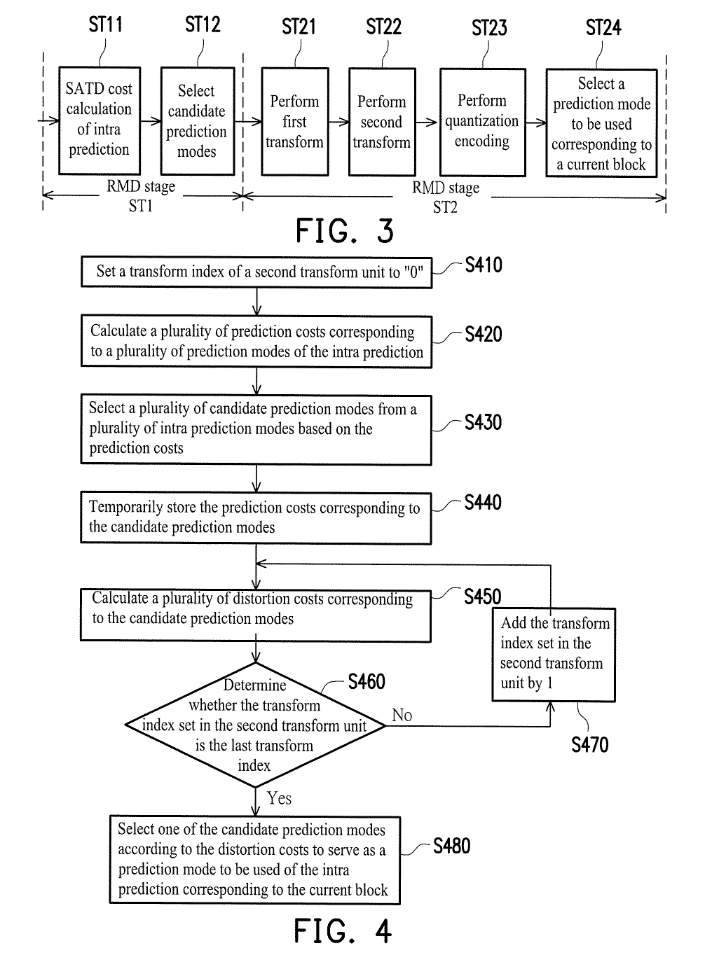

In the intra prediction technique of the JEM, a prediction mode of the intra prediction used for encoding the current block is determined through two stages. FIG. 3 is a schematic diagram of two stages of the intra prediction of the JEM. The first stage ST1 is a rough mode detection (RMD) stage. In detail, the RMD stage includes two sub stages ST11 and ST12. The two sub stages ST11 and ST12 may be implemented by the intra prediction unit 132 in FIG. 1. In the sub stage ST11, a sum of absolute transformed difference (SATD) manner is adopted to calculate prediction costs (which are also referred to as SATD costs) of a plurality of intra prediction modes (in the JEM, there are 35-67 intra prediction modes) corresponding to the current block, which is referred to as “SATD cost calculation of the intra prediction”. In the sub stage ST12, a plurality of candidate prediction modes is selected from the intra prediction modes based on the prediction costs, which is referred to as “to select candidate prediction mode”. A practiser of the disclosure may adjust an amount of the selected candidate prediction modes according to an actual requirement, for example, 3 or 5 intra prediction modes with lower SATD costs may be selected to serve as the candidate prediction modes. In the present embodiment, 3 intra prediction modes are selected to serve as the candidate prediction modes.

The second stage ST2 is a rate-distortion optimization (RDO) stage. In detail, the stage ST21 includes four sub stages ST21 to ST24. The sub stage ST21 may be implemented by the first transform unit 113 of FIG. 1; the sub stage ST22 may be implemented by the second transform unit 114 of FIG. 1; the sub stage ST23 may be implemented by the quantization unit 115 of FIG. 1; and the sub stage ST24 may be implemented by the intra prediction unit 132 or the quantization unit 115 of FIG. 1. The practiser of the disclosure may adjust and implement the function blocks of each of the aforementioned sub stages according to an actual requirement, which is not limited by the disclosure.

The sub stage ST21 is to perform the first transform/core transform/primary transform to the current block and the candidate prediction modes. Moreover, in order to strengthen the encoding effectiveness, in the sub stage ST22, the second transform (for example, the NSST) is performed to current block residual value data that has been subjected to the first transform. The sub stage ST23 is to perform quantization encoding to the current block residual value data that passes through the sub stage ST22 to calculate rate-distortion costs (RDCost) corresponding to each of the candidate perdition modes to serve as the distortion costs. In the present embodiment, the rate-distortion costs are taken as the distortion costs. The sub stage ST24 is to select the candidate prediction mode with the optimal rate-distortion cost between a quantity and a quantization distortion of real encoding bits to serve as a perdition mode to be used of the intra prediction corresponding to the current block, which is referred to as “to select the prediction mode to be used of the current block”.

In design of the JEM, the NSST has three transform units/transform cores, so that there are four operation modes. Theses operation modes are represented by different transform indexes. Therefore, each of the candidate prediction modes is required to respectively calculate under different NSST operation modes. It should be noted that the JEM has 67 intra prediction modes and four NSST operation modes (represented by NSST transform indexes (“0” to “3”)). In order to accurately calculate the optimal intra prediction modes, and since the different NSST operation modes may result in different results (selection of the candidate prediction modes) of the RDO stage, the JEM lets each of the intra prediction modes to respectively execute the RMD stage ST1 and the RDO stage ST2 under different NSST operation modes, so as to select the correct intra prediction modes.

According to another aspect, the NSST is adapted to the second transform of the intra prediction, so as to further reduce a bit number of the residual value. A processing flow for the intra mode selection of the aforementioned four NSST transform indexes is substantially described by following operation 1 to operation 8:

Operation 1: in the RMD stage when the NSST transforms index is “0” (to select 3 candidate prediction modes from 67 intra prediction modes based on the SATD costs);

Operation 2: in the RDO stage when the NSST transform index is “0” (to select the optimal intra prediction mode from the 3 candidate prediction modes);

Operation 3: in the RMD stage when the NSST transform index is “1” (to select 3 candidate prediction modes from 67 intra prediction modes based on the SATD costs);

Operation 4: in the RDO stage when the NSST transform index is “1” (to select the optimal intra prediction mode from the 3 candidate prediction modes);

Operation 5: in the RMD stage when the NSST transform index is “2” (to select 3 candidate prediction modes from 67 intra prediction modes based on the SATD costs);

Operation 6: in the RDO stage when the NSST transform index is “2” (to select the optimal intra prediction mode from the 3 candidate prediction modes);

Operation 7: in the RMD stage when the NSST transform index is “3” (to select 3 candidate prediction modes from 67 intra prediction modes based on the SATD costs);

Operation 8: in the RDO stage when the NSST transform index is “3” (to select the optimal intra prediction mode from the 3 candidate prediction modes).

Based on the aforementioned operations 1-8, it is learned that even if the SATD manner is an algorithm adapted to quickly calculate the intra prediction mode that is used for encoding the block to achieve the minimum cost, in the RMD stage, multiple calculations (for example, the operation 1, the operation 3, the operation 5 and the operation 7) have to be performed in order to calculate the minimum SATD cost in the 3 candidate prediction modes.

However, in the embodiment of the disclosure, it is regarded that in the sub stage ST11 of FIG. 3, calculation of the SATD costs is not directly related to the NSST operation modes. In other words, the calculation of the SATD costs and the NSST operation modes have little effect on the final video encoding result. Therefore, regarding the SATD costs of each of the intra prediction modes under different NSST transform indexes, a same group of the SATD costs may be used for calculation in different NSST operation modes in the following RDO stage. Therefore, in the embodiment of the disclosure, the SATD costs corresponding to the intra prediction modes are only calculated once when the NSST is set to the default transform index (for example, the NSST transform index is set to “0”), and the SATD costs are temporarily stored, and the step of “calculating the SATD costs when the NSST is set to other transform indexes (for example, the NSST transform index is set to “1” to “3”)” is removed, so as to greatly simplify the operation flow. In other words, in the embodiment of the disclosure, the calculation result of the SATD costs of the aforementioned operation 1 may be temporary stored, and the aforementioned operations 3, 5, 7 are omitted, and the SATD costs obtained in the operation 1 are used to perform the operations 4, 6, 8, so as to save a calculation amount.

FIG. 4 is a flowchart illustrating a method for selecting a prediction mode of an intra prediction according to an embodiment of the disclosure. The method of FIG. 4 is adapted to the video encoding device 100 of FIG. 1 and the image processing apparatus 200 of FIG. 2. Referring to FIG. 1 and FIG. 4, in step S410, the operation mode of the second transform unit 114 in the transform unit 112 is set to disable, i.e. the transform index of the second transform unit 114 is set to “0”. In step S420, under the situation that the second transform unit 114 operates according to the default transform index, the intra prediction unit 132 adopts the SATD manner to calculate a plurality of prediction costs corresponding to a plurality of prediction modes of the intra prediction according to the current block of the input image IM. The prediction costs are the SATD costs.

In step S430, the intra prediction unit 132 selects a plurality of candidate prediction modes from a plurality of intra prediction modes (for example, 67 intra prediction modes) based on the prediction costs of the step S420. In the present embodiment, the optimal prediction cost may be found from the prediction costs corresponding to the 67 intra prediction modes. The amount of the intra prediction modes is greater than a selected amount of the candidate perdition modes. For example, the three lowest prediction costs are found from the prediction costs, and the corresponding intra prediction modes are taken as the candidate prediction modes.

In step S440, after the candidate prediction modes are selected, the intra prediction unit 132 temporarily stores the prediction costs corresponding to the candidate prediction modes for the use of the following steps. In some embodiments, the intra prediction unit 132 may also temporarily store the prediction costs correspond to each of the intra prediction modes.

In step S450, a rate-distortion optimization (RDO) check may be performed through the first transform unit 113, the second transform unit 114 and the quantization unit 115 in the transform and quantization unit 110 based on the current block and the prediction costs corresponding to the candidate prediction modes selected in the step S430, so as to calculate a plurality of distortion costs corresponding to the candidate prediction modes under a plurality of transform indexes (the present embodiment has 4 transform indexes “0” to “3”). The distortion costs of the present embodiment are implemented by the rate-distortion costs mentioned in the sub stage ST23 of the RDO stage ST2 of FIG. 3. In other words, the calculation method of the distortion costs of the step S430 may refer to the RDO stage ST2 of FIG. 3.

In step S460, it is determined whether the transform index set in the second transform unit 114 is the last transform index (i.e. the transform index “3”). If the transform index set in the second transform unit 114 is not the transform index “3”, the flow enters a step S470 from the step S460 to add the transform index set in the second transform unit 114 by 1. Moreover, after the transform index is added by 1, the flow returns to the step S450 to calculate the distortion costs corresponding to each of the candidate prediction costs under the situation of the NSST transform index. Based on the steps S450 to S470, the distortion costs corresponding to the candidate prediction modes in case of different transform indexes may be calculated.

In the step S480, the intra prediction unit 132 (or other device executing the step S480) selects one of the candidate prediction modes according to the distortion costs calculated in the step S450 to serve as a prediction mode to be used of the intra prediction corresponding to the current block.

A following table 1 is a comparison of video compression rate and image quality obtained according to the embodiment of the disclosure. In the table 1, “Y”, “U”, “V” refer to a color encoding method, where “Y” represents luminance, “U” and “V” respectively represent chrominance and chroma.

TABLE 1

| Test pattern | Y | U | V | Coding time (%) |
|---|---|---|---|---|
| Pattern A1 | 0.02% | −0.11% | 0.00% | 90% |
| Pattern A2 | 0.03% | −0.04% | 0.07% | 92% |
| Pattern B | 0.02% | 0.07% | −0.04% | 91% |
| Pattern C | 0.01% | −0.07% | −0.04% | 90% |
| Pattern D | 0.03% | −0.14% | −0.01% | 92% |
| Pattern E | 0.04% | 0.06% | −0.09% | 92% |
| Average | 0.03% | −0.04% | −0.04% | 91% |

The table 1 lists a comparison result between the original patterns and the image that is first video encoded according to the embodiment of the disclosure and then decoded. The Y, U, V values of the image after the video encoding have little difference with that of the original patterns, though the encoding time is shortened by 9%, so that the processing speed of the video encoding is greatly increased.

In summary, when the method for selecting prediction mode of intra prediction, the video encoding device and the image processing apparatus select the prediction mode of the intra prediction, the transform unit is first set to the default transform index (for example, the transform unit is set to an operation mode that the second transform unit is disabled and only the first transform unit is used for transforming the residual value), and then the prediction costs corresponding to each of the prediction modes of the intra prediction are calculated based on the block of the input image, so as to select the candidate prediction modes from the prediction modes. Then, the candidate prediction mode with the optimal (for example, the lowest) distortion cost is selected from the candidate prediction modes according to the prediction costs corresponding to the candidate prediction modes and the block to serve as the prediction mode to be used. In other words, the embodiment of the disclosure does not respectively calculate the prediction cost corresponding to each of the prediction modes for different operation modes in the transform unit (i.e. in case that the residual value is transformed according to different transform indexes), but calculates the prediction costs corresponding to each of the prediction modes of the intra perdition once for a default operation mode of the transform unit (i.e. in case that the residual value is transformed according to the default transform index). Then, calculation of the distortion costs is implemented through the aforementioned prediction costs in collaboration with a situation that the transform unit transforms the residual value according to different transform indexes, so as to implement the subsequent selection of the candidate prediction modes. In this way, in the embodiments of the disclosure, a computation amount of the prediction costs is greatly decreased, the efficiency of video encoding and processing speed thereof are improved, and meanwhile the hardware implementation cost of the video encoding is decreased.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A method for selecting a prediction mode of an intra prediction, comprising:
calculating a plurality of prediction costs corresponding to a plurality of prediction modes of the intra prediction according to a block of an input image in case that a transform unit operates according to a default transform index;
selecting a plurality of candidate prediction modes from the prediction modes based on the prediction costs;
calculating a plurality of distortion costs corresponding to the candidate prediction modes under a plurality of transform indexes based on the block and the prediction costs corresponding to the candidate prediction modes, wherein the default transform index is one of the transform indexes; and
selecting one of the candidate prediction modes according to the distortion costs to serve as a prediction mode to be used of the intra prediction corresponding to the block.

2. The method for selecting the prediction mode of the intra prediction as claimed in claim 1, wherein the transform unit comprises a first transform unit and a second transform unit, and the second transform unit uses a non-separable secondary transform (NSST).

3. The method for selecting the prediction mode of the intra prediction as claimed in claim 2, wherein the second transform unit comprises at least one transform core,
the default transform index represents an operation mode that the transform unit does not use the second transform unit to transform a residual value of the block, and other transform indexes except the default transform index represent an operation mode that the transform unit uses one of the at least one transform core in the second transform unit to transform the residual value of the block.

4. The method for selecting the prediction mode of the intra prediction as claimed in claim 1, wherein a sum of absolute transformed difference (SATD) manner is adopted to calculate the prediction costs corresponding to the prediction modes in the intra prediction according to the block of the input image.

5. The method for selecting the prediction mode of the intra prediction as claimed in claim 1, wherein the distortion costs corresponding to the candidate prediction modes under the transform indexes is calculated by using a rate-distortion optimization (RDO) check and based on the block and the prediction costs corresponding to the candidate prediction modes.

6. The method for selecting the prediction mode of the intra prediction as claimed in claim 1, further comprising:
temporarily storing the prediction costs corresponding to the candidate prediction modes after selecting the candidate prediction modes.

7. The method for selecting the prediction mode of the intra prediction as claimed in claim 1, wherein a video encoding of the ultra prediction is a joint exploration test model (JEM), and an amount of the prediction modes is greater than an amount of the candidate prediction modes.

8. A video encoding device, comprising:
a transform unit, configured to transform a residual value corresponding to a block of an input image according to a plurality of transform indexes; and
an intra prediction unit, coupled to the transform unit, and in case that the transform unit operates according to a default transform index, the intra prediction unit obtaining the block of the input image, and calculating a plurality of prediction costs corresponding to a plurality of prediction modes of an intra prediction according to the block, wherein the default transform index is one of the transform indexes,
the intra prediction unit selects a plurality of candidate prediction modes from the prediction modes based on the prediction costs, calculates a plurality of distortion costs corresponding to the candidate prediction modes under the transform indexes of the transform unit based on the block and the prediction costs corresponding to the candidate prediction modes, and selects one of the candidate prediction modes according to the distortion costs to serve as a prediction mode to be used of the intra prediction corresponding to the block.

9. The video encoding device as claimed in claim 8, wherein the transform unit comprises:
a first transform unit, performing a first transform to the residual value; and
a second transform unit, selectively using a non-separable secondary transform (NSST) to the residual value subjected to the first transform to serve as a second transform, so as to generate a transformed residual value.

10. The video encoding device as claimed in claim 9, wherein the transform unit comprises at least one transform core,
the default transform index represents an operation mode that the transform unit does not use the second transform unit but uses the first transform unit to transform the residual value, and other transform indexes except the default transform index represent an operation mode that the transform unit uses one of the at least one transform core in the first transform unit and the second transform unit to transform the residual value.

11. The video encoding device as claimed in claim 8, wherein the intra prediction unit adopts a sum of absolute transformed difference (SATD) manner to calculate the prediction costs corresponding to the prediction modes in the intra prediction according to the block.

12. The video encoding device as claimed in claim 8, wherein the intra prediction unit calculates the distortion costs corresponding to the candidate prediction modes under the transform indexes by using a rate-distortion optimization (RDO) check and based on the block and the prediction costs corresponding to the candidate prediction modes.

13. The video encoding device as claimed in claim 8, wherein the intra prediction unit temporarily stores the prediction costs corresponding to the candidate prediction modes after selecting the candidate prediction modes.

14. The video encoding device as claimed in claim 8, wherein a video encoding used by the video encoding device is a joint exploration test model (JEM), and an amount of the prediction modes is greater than an amount of the candidate prediction modes.

15. An image processing apparatus, comprising:
a processor; and
a memory, coupled to the processor,
wherein the processor calculates a plurality of prediction costs corresponding to a plurality of prediction modes of an intra prediction according to a block of an input image in case of transforming a residual value according to a default transform index, wherein the residual value corresponds to the block, the processor selects a plurality of candidate prediction modes from the prediction modes based on the prediction costs, calculates a plurality of distortion costs corresponding to the candidate prediction modes under a plurality of transform indexes based on the block and the prediction costs corresponding to the candidate prediction modes, wherein the default transform index is one of the transform indexes, and
the processor selects one of the candidate prediction modes according to the distortion costs to serve as a prediction mode to be used of the intra prediction corresponding to the block.

16. The image processing apparatus as claimed in claim 15, wherein the processer performs a first transform to the residual value, and uses a non-separable secondary transform (NSST) to the residual value subjected to the first transform to serve as a second transform, so as to generate a transformed residual value.

17. The image processing apparatus as claimed in claim 16, wherein the second transform comprises at least one transform core,
the default transform index represents an operation mode that the processor does not use the second transform but uses the first transform to transform the residual value, and other transform indexes except the default transform index represent an operation mode that the processor uses one of the at least one transform core in the first transform and the second transform to transform the residual value.

18. The image processing apparatus as claimed in claim 15, wherein the processor adopts a sum of absolute transformed difference (SATD) manner to calculate the prediction costs corresponding to the prediction modes in the intra prediction according to the block.

19. The image processing apparatus as claimed in claim 15, wherein the processor calculates the distortion costs corresponding to the candidate prediction modes under the transform indexes by using a rate-distortion optimization (RDO) check and based on the block and the prediction costs corresponding to the candidate prediction modes.

20. The image processing apparatus as claimed in claim 15, wherein the processor temporarily stores the prediction costs corresponding to the candidate prediction modes after selecting the candidate prediction modes, and
a video encoding used by the image processing apparatus is a joint exploration test model (JEM), and an amount of the prediction modes is greater than an amount of the candidate prediction modes.
